(19) United States
(12) Patent Application Publication
(10) Pub. No.: US 2007/0206453 A1
(43) Pub. Date: Sep. 6, 2007

(54) Multilevel nano-structure optical media with oriented tracking marks

(75) Inventors: David S. Kuo, Palo Alto, CA (US); Neil Deeman, Alamo, CA (US); Shih-Fu Lee, Fremont, CA (US); Koichi Wago, Sunnyvale, CA (US)

Correspondence Address: SEAGATE TECHNOLOGY LLC;c/o MCDERMOTT WILL & EMERY LLP, 600 13TH STREET, NW, WASHINGTON, DC, 20005-3096, US

(73) Assignee: SEAGATE TECHNOLOGY LLC

(21) Appl. No.: 11/366,609

(22) Filed: Mar. 3, 2006

(51) Int. Cl. G11B 7/00

(52) U.S. Cl. 369/44.26; 369/275.3

(57) ABSTRACT

An optical data/information storage medium comprises a disk-shaped substrate with a data/information encoded surface having a plurality of concentric, radially spaced-apart data tracks formed therein, each of said data tracks comprising a plurality of spaced-apart, nano-dimensioned data pits or marks with different angular orientations with respect to a down-track direction of each data track. Each of the data tracks further comprises a plurality of spaced-apart, nano-dimensioned servo tracking pits or marks with a preselected angular orientation with respect to the down-track direction for use in obtaining radial error (RE) signals of a read-out head by means of radial push-pull (PP) or differential phase detection (DPD) tracking.

### FIELD OF THE INVENTION

The present invention relates to methodology and technology for optical read-out of disk-shaped optical data/information storage and retrieval media comprised of pits or marks configured as multilevel oriented nano-structures (ONS). The invention has particular utility in the use of ONS-type optical media with ultra-high data storage capacities in excess of about 150 Gbytes for disk diameters comparable to those of currently available CD and DVD media.

### BACKGROUND OF THE INVENTION

Oriented Nano-Structure (“ONS”) optical media provide storage capacities/densities which are increased by a factor as high as about 5, relative to the currently available CD, DVD, HD-DVD, etc., optical disk media. Advantageously, such ONS media and systems are backward compatible with the CD, DVD, HD-DVD technologies, and are suitable for use as small form-factor disks such as are currently employed in personal audio/video devices, e.g., Game Boys®, iPODS®, etc.

Referring to FIG. 1, the upper illustration is a plan view of a data track (or recording cell) of a conventionally encoded optical disk medium, showing a pattern comprised of a plurality of elongated marks or pits (dark areas) formed in the surface of the medium and the corresponding output pattern of a read head or photodetector which is produced by the pattern of marks or pits, wherein tₘᵢₙ indicates the minimum spacing between adjacent marks or pits which limits the maximum data encoding density and reading rate for a given disk rotation speed.

Still referring to FIG. 1, the lower illustration shows the expected output pattern of a read head or photodetector of a multi-states encoded ONS medium, wherein the surface of the medium includes a data track (or recording cell) with a pattern of marks or pits configured as multilevel, angularly oriented nano-structures. As is evident from a comparison of these illustrations, and noting that t<tₘᵢₙ, the areal recording density and data rate is significantly increased (i.e., ≧5×) in the multi-states encoded ONS medium by packing more information (i.e., M states) into the recording cell, while advantageously allowing operation with far-field optics similar to those of conventional optical drives.

Adverting to FIG. 2, shown therein are cross-sectional system views and plan views of the encoded surfaces of conventional CD, DVD, Blu-Ray® media, as well as ONS media, along with associated performance characteristics and operating parameters of each of these media types. As before, it is evident that ONS media offer significantly increased areal recording density and data rate vis-à-vis the earlier generations of optical media by virtue of: (1) decreased spacing between adjacent data tracks; (2) the ability to widely vary the angles of the pit or mark walls with respect to the data tracks, hence the encoding information; and (3) the increased pit or mark density along each data track.

ONS technology possesses the potential for becoming significantly more valuable than conventional optical disk technology, since “write once” and/or “re-writable” ONS disks can attain data storage capacities in the 150-1,000 Gbyte range when in a 5.25 in. diameter format and are usable equally well for content delivery (as in the current CD and DVD markets) and archival storage and retrieval applications.

Conventional optical disl data/information recording and storage systems, e.g., employing read-only and writable CD, DVD, etc., media, rely on a structure comprised of elongated pits or marks which are oriented and extend in a down-track direction and have diskrete lengths determined by the corresponding digital signal. The read-back signal is related to optical reflection changes which occur at the leading and trailing edges of the elongated pits or marks.

Optical disk media, such as conventional CD and DVD media, typically comprise a large number of spaced-apart, concentric data tracks, i.e., tracks where digital information is stored in the form of pits or marks, as described above, from which the recorded data/information is read or retrieved. The data tracks of the rotating disk are read via changes in the light reflected from the various pits or marks, which changes in reflected light are processed into an electrical signal.

For a disk having multiple concentric tracks, the direction along the track is generally referred to as the “down-track” direction, while the direction normal to the tracks is referred to as the radial or “cross-track” direction.

CD and DVD media may comprise data tracks which include servo fields or regions. Pits or marks in the servo fields are used for maintaining the laser beam from the read-out head in radial alignment with respect to the particular data track being read. As is evident from, e.g., U.S. Pat. Nos. 5,519,679; 6,233,209 B1; and 6,236,627 B1, the entire disclosures of which are incorporated herein by reference, a variety of configurations and positioning arrangements of the tracking pits or marks are possible. For example, the tracking pits or marks may be of different geometrical shapes and present as individual pits or marks, as radially aligned pairs of pits or marks, as pits or marks substantially centered on the data tracks, or as pits or marks located alongside the data tracks in the spaces between adjacent tracks. Reading and processing of signals corresponding to the pits or marks provide an indicia of the laser beam's radial position with respect to the track and allow for its correction. As a consequence, proper reading and processing of the data/information pits or marks on the track is better assured.

Consider, for example, a case where pairs of tracking pits or marks A and B are radially located between adjacent tracks on alternate sides of a particular track. If the laser beam is properly centered, the magnitudes of electrical output signals produced by a respective pair of photodetectors A and B (or photodetector segments A and B) from light which is reflected thereonto by the associated tracking pits or marks A and B will be equal. If the laser beam is off-center, the magnitudes of the electrical output signals from photodetectors A and B will not be equal, and an adjustment of the radial position of the laser beam is made by the servo tracking system, based upon the relative magnitudes of the electrical signals from photodetectors A and B. As indicated above, more complicated tracking systems may utilize additional tracking pits or marks and associated photodetectors or photodetector segments, e.g., quadrupole detectors with segments A, B, C, and D.

Referring to FIGS. 3(A)-3(C), DVD-ROM media with elongated, spaced-apart data pits or marks may utilize tracking error signals generated by a 4-quadrant photodetector and processed either by radial push-pull (PP) type methodology or differential phase detection (DPD) type methodology to determine a radial error signal (RE). As shown in FIG. 3(A) for PP methodology, the RE signal is defined as the difference between the sum of the output signals from detector quadrants A and C and the sum of the output signals from detector quadrants B and D, i.e., RE=(A+C)−(B+D); whereas, as shown in FIG. 3(B) for DPD methodology, the RE is determined from the phase difference between ƒ₁=A +D and ƒ₂=B +C, wherein the former is the sum of the output signals from detector quadrants A and D and the latter is the sum of the output signals from detector quadrants B and C. FIG. 3(C) graphically illustrates the variation of the RE signal as a function of the radial position of the read-out head for each of these methodologies. As may be evident from FIG. 3(C), the RE signal as determined by the DPD type methodology is linear over a greater range than when determined by the PP type methodology.

In contrast with conventional CD and DVD media, however, the data/information marks or pits utilized in ONS optical media, as for example illustrated in FIGS. 2 and 4, are of different orientations with respect to the down-track direction of the data track. In addition, they may be of different widths, i.e., width-modulated. As a consequence, they cannot be utilized as tracking marks or pits for generating the required photodetector output signals or phase differences for tracking by either the PP or DPD methodology described above.

Accordingly, there exists a clear need for improved means and methodology for performing tracking of the encoded data tracks of multilevel ONS optical data/information storage media in order to provide proper read-out of the stored data/information by the optical head.

### SUMMARY OF THE INVENTION

An advantage of the present invention is improved multilevel ONS optical data/information storage media.

Another advantage of the present invention is improved methods of performing servo tracking of the radial position of a read-out head of an optical data/information storage and retrieval system comprising a multilevel ONS optical storage medium.

Additional advantages and other features of the present invention will be set forth in the description which follows and in part will become apparent to those having ordinary skill in the art upon examination of the following or may be learned from the practice of the present invention. The advantages of the invention may be realized and obtained as particularly pointed out in the appended claims.

According to an aspect of the present invention, the foregoing and other advantages are achieved in part by an improved optical data/information storage medium, comprising a disk-shaped substrate with a data/information encoded surface having a plurality of concentric, radially spaced-apart data tracks formed therein, each of the data tracks comprising:

(a) a plurality of discrete data zones, each data zone including a plurality of spaced-apart, nano-dimensioned data pits or marks with different angular orientations with respect to a down-track direction of the data track; and

(b) a servo tracking zone between each data zone, each servo tracking zone comprising at least one nano-dimensioned servo tracking pit or mark with a preselected angular orientation with respect to the down-track direction.

According to preferred embodiments of the present invention, each of the servo tracking zones comprises a plurality of servo tracking pits or marks arranged in a fixed pattern; the servo tracking zones separate adjacent data zones by regular intervals along the down-track direction; and a sufficient number of the servo tracking pits or marks are present in a given down-track segment of each data track for obtaining radial error (RE) signals by means of radial push-pull (PP) or differential phase detection (DPD) tracking, e.g., each data track includes one servo tracking pit or mark for each down-track segment containing ten data marks or pits.

Another aspect of the present invention is an improved optical data/information storage medium, comprising a disk-shaped substrate with a data/information encoded surface having a plurality of concentric, radially spaced-apart data tracks formed therein, each of the data tracks including a plurality of data zones, each data zone extending along a down-track direction for a length corresponding to a preselected peak direction period and comprising:

(a) a plurality of spaced-apart, nano-dimensioned data pits or marks with different angular orientations with respect to the down-track direction of the data track; and

(b) at least one peak detection pit or mark with a preselected angular orientation with respect to the down-track direction.

Yet another aspect of the present invention is an improved method of performing servo tracking of the radial position of a read-out head of an ONS optical data/information storage and retrieval system, the ONS system including a disk-shaped optical data/information storage medium with a plurality of concentric, radially spaced-apart data tracks formed in a surface of the medium, each of the data tracks comprising a plurality of discrete data zones, each data zone including a plurality of spaced-apart, nano-dimensioned data pits or marks with different angular orientations with respect to a down-track direction of the data track, each of the data tracks further comprising a servo tracking zone between each data zone, each servo tracking zone comprising at least one nano-dimensioned servo tracking pit or mark with a preselected angular orientation with respect to the down-track direction, the method comprising utilizing the servo tracking pits or marks for determining a radial error (RE) signal indicating tracking error of the read-out head.

According to preferred embodiments of the present invention, each of the servo tracking zones comprises a plurality of the servo tracking pits or marks arranged in a fixed pattern; the servo tracking zones separate adjacent data zones by regular intervals along the down-track direction; and a sufficient number of the servo tracking pits or marks are present in a given down-track segment of each data track for obtaining radial error (RE) signals by means of radial push-pull (PP) or differential phase detection (DPD) tracking, e.g., each data track includes one servo tracking pit or mark for each down-track segment containing ten data marks or pits.

A further aspect of the present invention is an improved method of performing servo tracking of the radial position of a read-out head of an ONS optical data/information storage and retrieval system, the ONS system including a disk-shaped optical data/information storage medium with a plurality of concentric, radially spaced-apart data tracks formed in a surface of the medium, each of the data tracks comprising a plurality of data zones extending along a down-track direction for a length corresponding to a preselected peak direction period and comprising a plurality of spaced-apart, nano-dimensioned data pits or marks with different angular orientations with respect to the down-track direction and at least one peak detection pit or mark with a preselected angular orientation with respect to the down-track direction, the method comprising detecting and utilizing at least one peak signal from the at least one peak detection mark or pit within the preselected peak detection period for performing the servo tracking.

Additional advantages and features of the present invention will become readily apparent to those skilled in the art from the following detailed description, wherein only the preferred embodiments are shown and described, simply by way of illustration of the best mode contemplated for practicing the present invention. As will be described, the present invention is capable of other and different embodiments, and its several details are susceptible of modification in various obvious respects, all without departing from the spirit of the present invention. Accordingly, the drawings and description are to be regarded as illustrative in nature, and not as limitative.

### BRIEF DESCRIPTION OF THE DRAWINGS

The following detailed description of the embodiments of the present invention can best be understood when read in conjunction with the following drawings, in which the various features are not necessarily drawn to scale but rather are drawn as to best illustrate the pertinent features, wherein:

FIG. 1 is an illustration for comparing data/information encoding densities of conventional optical recording media and multi-states (or multilevel) ONS optical media according to the present invention;

FIG. 2 illustrates cross-sectional system views and plan views of data encoded surfaces of several types of conventional optical storage media and multi-states (or multilevel) ONS optical media according to the present invention;

FIG. 3(A) schematically illustrates generation of radial tracking error (RE) signals utilizing radial push-pull (PP) type methodology;

FIG. 3(B) schematically illustrates generation of RE signals utilizing differential phase detection (DPD) type methodology;

FIG. 3(C) graphically illustrates the variation of the RE signal as a function of the radial position of a read-out head according to the PP and DPD methodologies;

FIG. 4 is a schematic plan view of a segment of a data track of an ONS optical medium, illustrating nano-dimensioned (or nano-structured) data pits or marks with various orientations with respect to the down-track direction;

FIG. 5(A) is a simplified, schematic plan view of a portion of a data track of an ONS optical recording medium according to an embodiment of the present invention, illustrating a pair of discrete data zones each comprised of a plurality of nano-dimensioned, angularly oriented data pits or marks spaced apart by servo tracking zones each comprised of a plurality of nano-dimensioned servo tracking pits or marks each with a preselected (cross-track) orientation with respect to the down-track direction of the data track; and

FIG. 5(B) is a simplified, schematic plan view of a portion of a data track of an ONS optical recording medium according to another embodiment of the present invention, illustrating a data zone comprised of a plurality of nano-dimensioned, angularly oriented data pits or marks and operationally divided into a plurality of peak detection periods, each peak detection period including one or more nano-dimensioned peak signal pits or marks each with a preselected (cross-track) orientation.

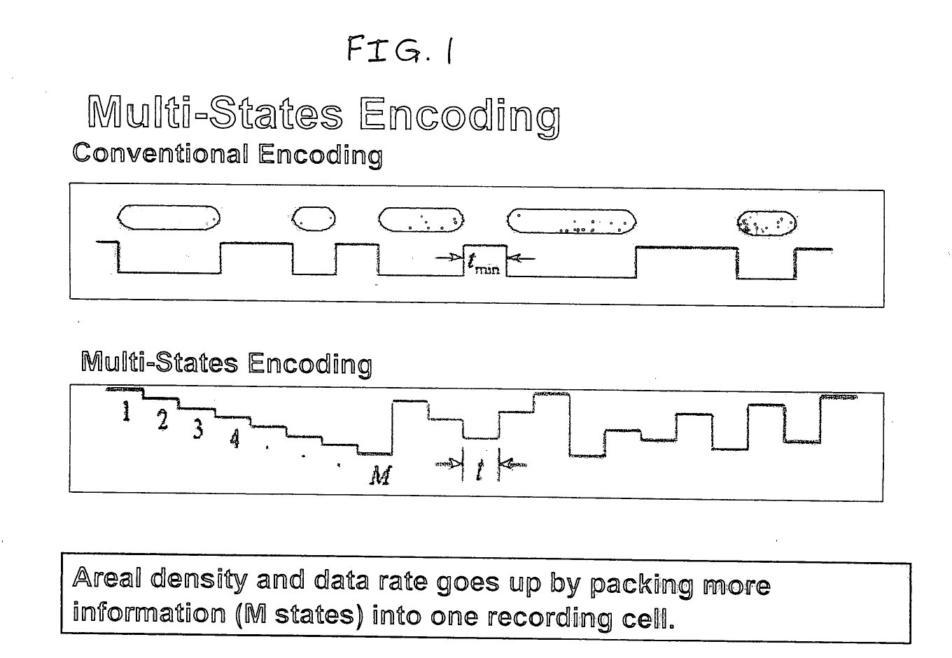

### DETAILED DESCRIPTION OF THE INVENTION

As indicated above, and in contrast with conventional optical disk technology for data/information storage and retrieval, ONS optical disk technology utilizes angularly oriented marks or pits in the disk surface for encoding of the data/information, as for example, illustrated in FIG. 4 described supra. However, the irregular nature of the data pits or marks, i.e., their variation in angular orientation (and width in some instances), renders them unsuitable for use as tracking pits or marks for maintaining the read head in proper radial alignment with the various data tracks as the disk rotates during operation.

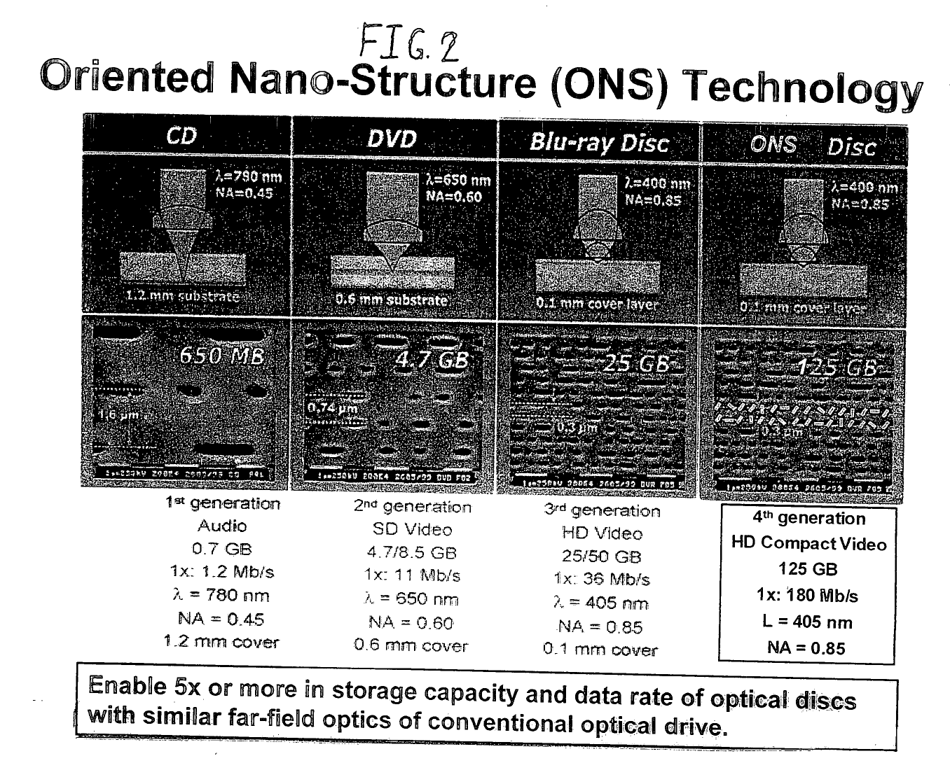

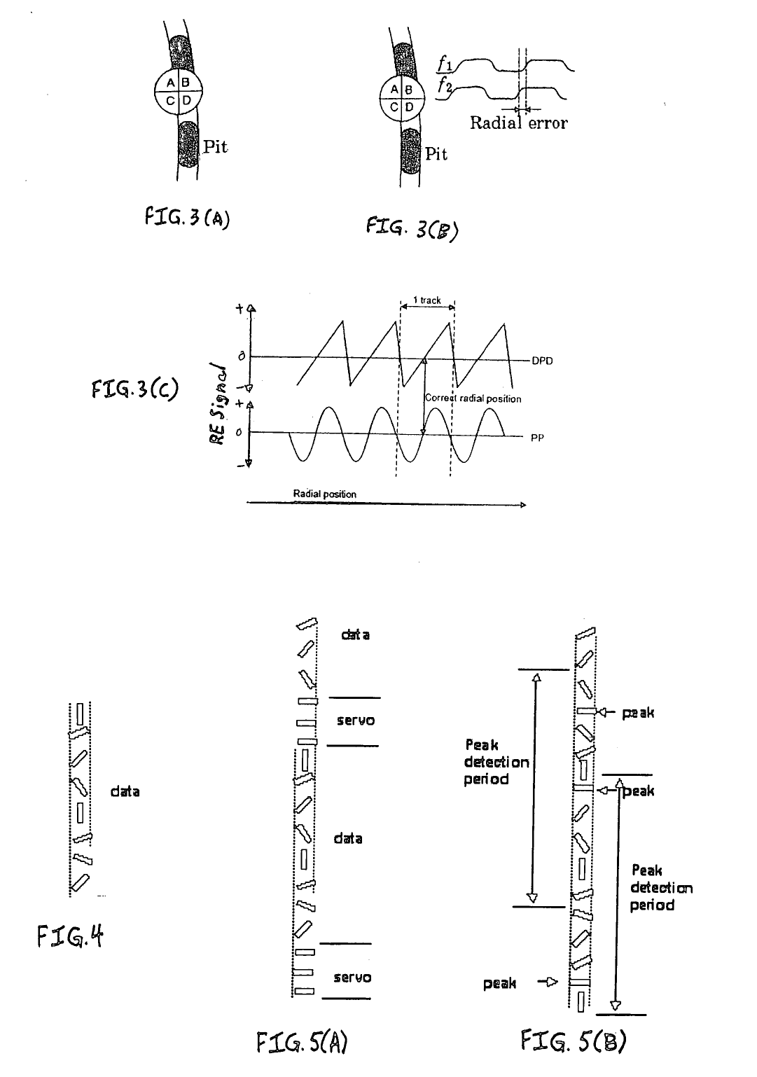

The present invention, therefore, has as a principal aim, provision of multilevel ONS optical media with appropriately configured and arranged tracking pits or marks enabling accurate generation of radial tracking error (RE) signals from a read-out head equipped with a photodetector unit, utilizing conventional push-pull (PP) type and/or differential phase detection (DPD) type methodology (as described above with respect to FIGS. 3(A)-3(C)).

According to an embodiment the invention, each data track is provided with a sufficient number of nano-dimensioned tracking pits or marks having a preselected orientation with respect to a down-track direction of the data track for providing usable photodetector output signals for PP and/or DPD signal processing.

Referring to FIG. 5(A), shown therein is a simplified, schematic plan view of a portion of a data track of an ONS optical recording medium according to an embodiment of the present invention, illustrating a pair of discrete data zones each comprised of a plurality of nano-dimensioned, angularly oriented data pits or marks spaced apart by servo tracking zones each comprised of a plurality of nano-dimensioned servo tracking pits or marks each with a preselected angular orientation with respect to the down-track direction of the data track.

It should be noted that while the preselected arrangement of servo tracking pits or marks shown in FIG. 5(A) is shown as three (3) horizontally, i.e., cross-track, orientated pits or marks, such arrangement is merely illustrative of the versatility of the present invention and thus non-limitative, and other preselected angular orientations/patterns are equally usable according to the invention. For example, the preselected arrangement or pattern of servo tracking pits or marks can be of complex design, not limited to three pits or marks and consisting of a combination of variously angularly oriented nano-dimensioned pits or marks.

According to the embodiment of the invention:
1. each of the servo tracking zones comprises a plurality of servo tracking pits or marks arranged in a fixed pattern;
2. the servo tracking zones separate adjacent data zones by regular intervals along the down-track direction; and
3. a sufficient number of the servo tracking pits or marks are present in a given down-track segment of each data track for obtaining radial error (RE) signals by means of radial push-pull (PP) or differential phase detection (DPD) tracking, e.g., each data track includes one servo tracking pit or mark for each down-track segment containing ten data marks or pits.

Adverting to FIG. 5(B), shown therein is a simplified, schematic plan view of a portion of a data track of an ONS optical recording medium according to another embodiment of the present invention, illustrating a data zone comprised of a plurality of nano-dimensioned, angularly oriented data pits or marks and operationally divided into a plurality of peak detection periods, each peak detection period including one or more nano-dimensioned peak signal pits or marks each with a preselected orientation.

It should be noted that while in the embodiment shown in FIG. 5(B), each peak detection period of the data track is shown as comprising two (2) horizontally, i.e., cross-track, orientated peak detection pits or marks, such arrangement is merely illustrative of the versatility of the present invention and thus non-limitative, and other angular orientations and numbers of peak detection pits or marks are equally usable according to the invention.

According to this embodiment, the encoded data has a limited run length, and the channel can detect the peak signals within a fixed length of the data track and utilize the detected signal for servo tracking. The method comprises detecting and utilizing at least one peak signal from at least one peak detection pit or mark within the preselected peak detection period for performing servo tracking.

Provision of tracking or servo detection peak pits or marks as illustrated in FIGS. 5(A) may result in redefinition of the run length limitation (RLL). Depending upon the bandwidth equivalent length and the data encoding RLL, configurations/arrangements of tracking pits or marks according to the invention, as for example, exemplified in FIG. 5(A), must accommodate whichever length is shorter.

Advantageously, however, configurations/arrangements of tracking pits or marks such as shown in FIG. 5(A) yield PP and/or DPD RE signals with profiles similar to those provided in conventional optical disk media, e.g., as illustrated in FIGS. 3(A)-3(C) described supra.

The number of tracking pits or marks per data tracking pits or marks, i.e., tracking pit frequency, is readily determined for a particular application or system. For example, 1 tracking pit or mark can be provided for every 10 data pits or marks, or, for example, a plurality of data pits or marks can be provided (as illustrated in FIG. 5(A). In this regard, consider a case where a typical track oscillation is about 100 μm/rotation. Assuming ±50 μm oscillations occur at ID=15 mm, and the track pitch/data mark pitch ratio is about 1, there will be about 1,000 marks crossed by the read-out head before the latter crosses one track. In that instance, there will bee about 100 tracking pits or marks available for generating a RE signal via PP or DPD technology.

Another analysis of RE generation utilizes the signal bandwidth as a reference. For example, a 30 kHz low-pass filter is typically specified for use with PP and DPD RE tracking signals. Assuming the disk rotates at about 1,800 rpm at 15 mm and the mark pitch is 0.2 μm, for a 1 tracking pit or mark per 10 data pits or marks design, there would be at least 25 tracking pits or marks available for yielding averaged signals of time difference in the ƒ₁ and ƒ₂ phases.

A penalty associated with the above approaches is a slight loss in data/information storage density/capacity.

In the previous description, numerous specific details are set forth, such as specific materials, structures, processes, etc., in order to provide a better understanding of the present invention. However, the present invention can be practiced without resorting to the details specifically set forth. In other instances, well-known processing materials and techniques have not been described in detail in order not to unnecessarily obscure the present invention.

Only the preferred embodiments of the present invention and but a few examples of its versatility are shown and described in the present disklosure. It is to be understood that the present invention is capable of use in various other combinations and environments and is susceptible of changes and/or modifications within the scope of the inventive concept as expressed herein.

What is claimed is:

1. An optical data/information storage medium, comprising a disk-shaped substrate with a data/information encoded surface having a plurality of concentric, radially spaced-apart data tracks formed therein, each of said data tracks comprising:
(a) a plurality of discrete data zones, each data zone including a plurality of spaced-apart, nano-dimensioned data pits or marks with different angular orientations with respect to a down-track direction of said data track; and
(b) a servo tracking zone between each data zone, each servo tracking zone comprising at least one nano-dimensioned servo tracking pit or mark with a preselected angular orientation with respect to said down-track direction.

2. The medium as in claim 1, wherein:
each of said servo tracking zones comprises a plurality of said servo tracking pits or marks arranged in a fixed pattern.

3. The medium as in claim 2, wherein said servo tracking zones separate adjacent data zones by regular intervals along said down-track direction.

4. The medium as in claim 1, wherein a sufficient number of said servo tracking pits or marks are present in a given down-track segment of each data track for obtaining radial error (RE) signals by means of radial push-pull (PP) or differential phase detection (DPD) tracking.

5. The medium as in claim 4, wherein each data track includes one servo tracking pit or mark for each down-track segment containing ten data marks or pits.

6. An optical data/information storage medium, comprising a disk-shaped substrate with a data/information encoded surface having a plurality of concentric, radially spaced-apart data tracks formed therein, each of said data tracks including a plurality of data zones, each data zone extending along a down-track direction for a length corresponding to a preselected peak direction period and comprising:
(a) a plurality of spaced-apart, nano-dimensioned data pits or marks with different angular orientations with respect to said down-track direction of said data track; and
(b) at least one peak detection pit or mark with a preselected angular orientation with respect to said down-track direction.

7. A method of performing servo tracking of the radial position of a read-out head of an ONS optical data/information storage and retrieval system, said ONS system including a disk-shaped optical data/information storage medium with a plurality of concentric, radially spaced-apart data tracks formed in a surface of said medium, each of said data tracks comprising a plurality of discrete data zones, each data zone including a plurality of spaced-apart, nano-dimensioned data pits or marks with different angular orientations with respect to a down-track direction of said data track, each of said data tracks further comprising a servo tracking zone between each data zone, each servo tracking zone comprising at least one nano-dimensioned servo tracking pit or mark with a preselected angular orientation with respect to said down-track direction, said method comprising utilizing said servo tracking pits or marks for determining a radial error (RE) signal indicating tracking error of said read-out head.

8. The method according to claim 7, wherein each of said servo tracking zones comprises a plurality of said servo tracking pits or marks arranged in a fixed pattern.

9. The method according to claim 8, wherein:
said servo tracking zones separate adjacent data zones by regular intervals along said down-track direction.

10. The method according to claim 7, wherein a sufficient number of said servo tracking pits or marks are present in a given down-track segment of each data track for obtaining radial error (RE) signals by means of radial push-pull (PP) or differential phase detection (DPD) tracking.

11. The method according to claim 10, wherein each data track includes one servo tracking pit or mark for each down-track segment containing ten data marks or pits.

12. A method of performing servo tracking of the radial position of a read-out head of an ONS optical data/information storage and retrieval system, said ONS system including a disk-shaped optical data/information storage medium with a plurality of concentric, radially spaced-apart data tracks formed in a surface of said medium, each of said data tracks comprising a plurality of data zones extending along a down-track direction for a length corresponding to a preselected peak detection period and comprising a plurality of spaced-apart, nano-dimensioned data pits or marks with different angular orientations with respect to said down-track direction and at least one peak detection pit or mark with a preselected angular orientation with respect to said down-track direction, said method comprising detecting and utilizing at least one peak signal from said at least one peak detection pit or mark within said preselected peak detection period for performing said servo tracking
